(19) United States
(12) Patent Application Publication
(10) Pub. No.: US 2024/0330860 A1
(43) Pub. Date: Oct. 3, 2024

(54) Smart Contract Integrated Collaborative Crowdwork System and Method

(71) Applicant: David Andrew Bulloch Hyde, Nashville, TN (US)

(72) Inventor: David Andrew Bulloch Hyde, Nashville, TN (US)

(21) Appl. No.: 18/194,836

(22) Filed: Apr. 3, 2023

(51) Int. Cl. G06Q 10/101; G06Q 10/10

(52) U.S. Cl. CPC G06Q 10/101; G06Q 10/103

(57) ABSTRACT

A system and method are presented for performing actions in a collaborative and potentially continuous manner. The actions and the reward for performing the actions can be defined by a blockchain-based smart contract. A project defines the actions to be performed, the data upon which to act, and reward. The project definition is used to establish the smart contract. Multiple agent computers receive data and interfaces sufficient to perform the actions on the data. Collaboration tools can be provided through the agent computer systems to allow communications and other interactions between agent computer systems.

### FIELD OF THE INVENTION

This invention relates to the field of blockchain technology and smart contracts utilized for collaborative work.

### BACKGROUND OF THE INVENTION

Trust is a central issue in digital markets. This is true regardless of the form of the digital market, including peer-to-peer markets (like Craigslist, provided by Craigslist Inc. of San Francisco, CA), centralized markets (like that provided by Amazon.com, Inc. of Seattle, WA), markets with intermediaries (like eBay, provided by eBay Inc. of San Jose, CA), etc. The success of a centralized market depends on users trusting the centralized authority, which may be capricious or malignant. On the other hand, a decentralized market generally has fewer or no guarantees or dispute resolution mechanisms, which can also inhibit trust. Generally, imperfect trust is a marketplace inefficiency, and markets will generally perform best when either all participants have full trust or when the market inherently requires no trust.

Blockchains can be used to perform trust-free interactions. Blockchain technology refers to a model of distributed computational recordkeeping wherein the validity of the records in the “ledger” is mathematically provable (or disprovable) and is enforced by collective computational action of participants in the network. While blockchain networks have many participants acting anonymously, verification protocols provide probabilistic guarantees against malicious behavior of the participants.

A blockchain ledger may track any type of information. A popular realization of blockchain technology has been interpreting ledger entries as balances of tokens, which may have monetary value. Bitcoin and Ethereum are two types of token-based “cryptocurrencies.”

A smart contract is a contract that is written in code that is stored, at least in part, on the blockchain. Certain blockchains, such as the Ethereum blockchain, support programming languages that have been designed for the recordation and performance of smart contracts. Participants can execute the instructions of the smart contract knowing that the computations will be “verified” or “guaranteed” by virtue of the cryptographic protocol of the Ethereum blockchain. The instructions in a smart contract may involve transactions between multiple parties, such as describing a transfer of funds between parties to occur at a certain time, or they may involve computational procedures. Trust-free sales or exchanges can be performed between users by using smart contracts as intermediary-free escrow accounts.

### SUMMARY OF THE INVENTION

The embodiments described herein use networked systems and blockchain technology to create a system and method for collaborative action. In particular, the embodiments facilitate real-time collaborative actions (or computations) by using a blockchain-based smart contract to verify those actions and provide incentives for performing those actions.

The described system can utilize standardized interfaces, methods, and formats for participants to interact with or participate in the system. One such interface is provided on a project submission computer to select a standardized type of project and select parameters for that project. The parameters might specify a data source, the type of action to be performed for the project, verification requirements for individual actions, incentives to be provided per action, and an overall funding level.

The selection of the type of project and the individual parameters guide a system server to generate a smart contract and activate that smart contract as the action contract for the project on a blockchain. The same information will guide the system server to present the project and necessary actions on a marketplace for selection by a variety of agent computer systems.

Upon selection of a project by a plurality of agent computer systems, the server system generates an agent computer interface for presentation to agents that can perform those actions. This interface is again governed by the type of project and individual parameters specified as part of the project.

The agent computer interface is presented on the plurality of agent computer systems along with data (such as images) from the data source for the project. The agent computer interfaces present the data on the plurality of agent computer systems and allow input of the results of human analysis of the data. Collaboration tools can be provided through the agent computer systems to allow communications and other interactions between agent computer systems working on the same project. The results of this analysis are submitted to the action contract on the blockchain for verification and requirements analysis. In some embodiments, the results are submitted to the action contract through the system server, which may perform pre-analysis or formatting as required for input into the smart action contract on the blockchain.

The action contract responds to analysis results according to its programming. Verification routines specified in the smart contract verify the results. Requirements for compensation are analyzed, and if the verification and requirements are satisfied, the smart contract initiates a transfer of tokens to addresses associated with the responding agent computer systems.

In other embodiments, the server presents data and instructions for processing to a plurality of agent computer systems. Rather than presenting a user interface for human analysis, the agent computer systems then utilize these instructions to present the data to artificial intelligence algorithms for analysis of the data and the generation of results.

### BRIEF DESCRIPTION OF THE DRAWINGS

FIG. 1 is a schematic view of a system utilized in one embodiment of the present invention.

FIG. 2 is a flow chart showing a process that can be performed on the system of FIG. 1.

FIG. 3 is a schematic view of data flow between the elements of the system of FIG. 1 during the process described in FIG. 2.

FIG. 4 is schematic diagram of an agent computer interface.

FIG. 5 is a schematic view of a second embodiment system for the present invention.

FIG. 6 is a schematic view of a portion of FIG. 1 modified to include artificial intelligence algorithms.

### DETAILED DESCRIPTION

### Recognition of the Need for Human in the Loop Collaborative Processing

Platforms such as the Berkeley Open Infrastructure for Network Computing (BOINC) facilitate users donating their computational power to research projects that distribute software tasks to be run on users' machines. While BOINC allows for collaborative work by a variety of disparate computers, there is no mechanism for any user or human involvement in the work process. Humans are capable of performing certain tasks much more efficiently and accurately than computer systems. Steps are being made to replace human computation power by automated systems, but these systems are still far from perfect. For example, autonomous vehicles utilize expensive computer systems and advanced algorithms for tasks such as pedestrian detection while driving, even though humans can still more accurately perform these tasks.

There is currently no automated platform for collaborative task performance by which humans can participate in real-time analysis or processing of data and then return results or responses to the platform. To accomplish this, human performance must also be verified in real-time. Many software systems like Apache Spark and AWS Kinesis are designed to facilitate computational processing of data in real- or near-real-time, but these systems are generally not capable of human-in-the-loop computation and do not perform computation in a verified way.

Digital labor markets do exist, in forms such as Fiverr, Angie's List, and Uber, that facilitate connecting consumers with service providers. Amazon Mechanical Turk is a digital labor market where discrete tasks are offered to be completed by an anonymous pool of human workers. Mechanical Turk is centralized, with Amazon being responsible for adding and removing workers and labor providers to and from its platform, and for collecting and disbursing payments. Tasks in Mechanical Turk are discrete, not continuous; there are clear starting and stopping conditions as opposed to potentially returning to perform additional work on a task on an ongoing basis. Moreover, Mechanical Turk is designed for one-to-one matching of workers to tasks. Mechanical Turk does not provide for collaborative working with multiple workers together completing a task. It is also not practical to guarantee when jobs will be performed, which makes Mechanical Turk an inappropriate solution for real-time data processing. Therefore, the present application recognizes that there is an absence of decentralized digital markets that facilitate real-time verifiable action performed by human agents in a potentially collaborative process.

### System 100

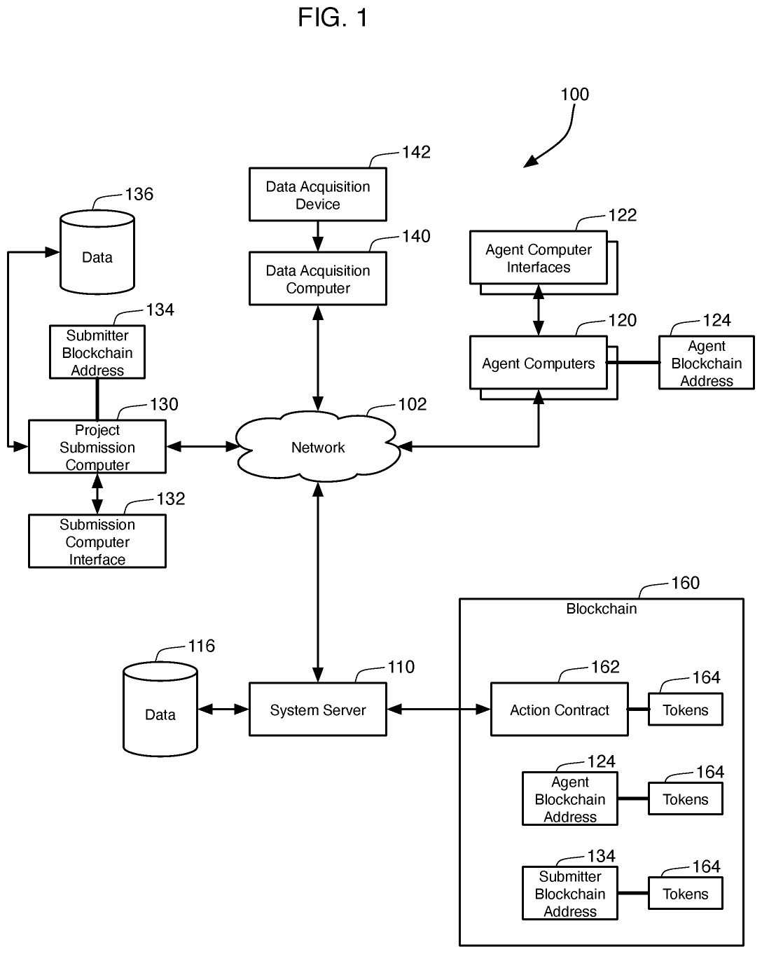

FIG. 1 is a schematic diagram of system 100 that can be used in connection with the present invention. In system 100, a system server 110 manages interactions between a plurality of agent computers 120, a project submission computer 130, and a data acquisition computer 140 over a network 102. The network could be any wide area network, including the Internet. The data acquisition computer 140 is utilized to collect data from a data acquisition device 142 (such as a still or video camera) and share this data over the network 102.

The system server 110, the agent computers 120, the project submission computer 130, and the data acquisition computer 140 are all computing devices utilizing a programmed processor to perform automated processes. As such, the computing devices 110, 120, 130, 140 all contain a computer processor and data storage or memory (collectively referred to herein as memory), including short term memory such as RAM and long-term memory such as flash storage. Programming for the processor is stored in and retrieved from the memory, and data acquired and created by the processor is also stored in and retrieved from the memory. These computing devices 110, 120, 130, 140 can be a standard computer, such as a desktop computer, a laptop computer, or a server system. Alternatively, they may comprise mobile devices, including smart phones or tablet computers. In addition, the computing devices 110, 120, 130, 140 may comprise one or more Internet of Things (IoT) devices that are capable of receiving data locally over a network or from attached sensors, processing that data, and then either storing the processed data locally or presenting it back over the network.

In one embodiment, the project submission computer 130 may submit a project to the system server 110 relating to data provided by the data acquisition computer 140. In particular, the project submission computer 130 may wish a plurality of agent computers 120 to analyze data created by the data acquisition device 142. This analysis may need to be continuous or otherwise ongoing, such as a need for monitoring systems or cameras that provide a continuous stream of data. For this monitoring/analysis to occur, the system server 110 must create, or must assist the project submission computer 130 in creating, an action contract 162 on the blockchain 160 and agent computer interfaces 122 that will be presented by the agent computers 120.

For example, the project submission computer 130 may wish to have users of the agent computers 120 monitor images created by the data acquisition device 142. This monitoring may require the users of the agent computers 120 to identify when an object appear within the images.

The submission of a project by the project submission computer 130 will occur through a submission computer interface 132. Similarly, the monitoring will be accomplished using agent computer interfaces 122. Each of those interfaces could be created in a variety of ways. In one embodiment, it is the system server 110 that generates and provides the submission computer interface 132 to the project submission computer 130 and the agent computer interfaces 122 to the agent computers 120. This can be accomplished by creating web pages to be presented over network 102, with the project submission computer 130 and the agent computers 120 each having browser software that receives the web pages and presents them as the submission computer interface 132 and the agent computer interfaces 122 respectively.

To incentivize users of the agent computers 120, the action contract 162 must be funded. In some embodiments, the action contract 162 is funded through tokens 164 previously established on the blockchain 160. In the context of this disclosure, a “token” 164 may comprise a sub-portion of another token, such as a “satoshi,” which comprises one 100,000,000^{th} of a bitcoin. Thus, the transfer of “tokens” 164 to an address in the following description could result in only a fraction of a full cryptocurrency token being transferred. These tokens 164 might be tokens for the cryptocurrency established at the formation of the blockchain 160 (such as Ethereum tokens on the Ethereum blockchain) or may be other tokens (including other cryptocurrencies) established by other smart contracts on the blockchain 160.

The funding of an action contract 162 can occur when the action contract 162 was first created, or it can be accomplished at a later time. Funding effectively places tokens 164 under the control (or ownership) of the action contract 162. The action contract 162 then has the ability to transfer some portion of these tokens 164 from its own blockchain address to another blockchain address. In FIG. 1, agent blockchain address 124 is associated with a particular one of the agent computers 120, while submitter blockchain address 134 is associated with the project submission computer 130. These blockchain addresses 124, 134 are sometimes referred to as a wallet addresses. While this description refers to the blockchain addresses 124, 134 being associated with a computer 120, 130, it is more likely that these addresses are associated with particular users of these computers 120, 130. Nonetheless, the addresses 124, 134 will be associated with actions on the computers 120, 130, and so the associations with computers 120, 130 is still accurate.

The action contract 162 can transfer tokens 164 from its own ownership to the ownership of the agent blockchain address 124 whenever the action contract 162 has determine that an action it is monitoring was successfully performed by the agent computer interface 122 associated with that agent blockchain address 124. Tokens 164 can also be assigned to the blockchain address 134 associated with the project submission computer 130, which would be appropriate if a refund is being made at the conclusion of an action contract 162.

The action contract 162 is written to monitor the activities of the agent computer interfaces 122 to determine whether or not the requested action has been performed. For instance, the code in the action contract 162 could check that a particular agent computer interface 122 has presented an image from the data acquisition device 142, and that the agent computer interface 122 has provided a response as to whether the image contains a certain object or not.

The monitoring performed by the action contract 162 is, in one embodiment, facilitated by the system server 110. While the agent computer interfaces 122 can be written so as to submit requests directly to the action contract 162 on the blockchain 160, it is sometimes preferred that all such communications pass through the system server 110. In system 100, the system server 110 is responsible for creating the agent computer interfaces 122, for transferring data received from the data acquisition device 142 to the agent computer interfaces 122, and for forwarding data generated by the agent computer interfaces 122. The data generated by the agent computer interfaces 122 can be submitted in its entirety to the action contract 162 on the blockchain 160. Alternatively, the data generated by the agent computer interfaces 122 can be pre-analyzed by programming on the system server 110 such that the system server 110 can determine when such communications with the action contract 162 take place, and the format of such communications.

Data related to the system 100 can be stored in a variety of locations. In FIG. 1, the system server 110 stores data in, and retrieves data from, a system data store 116, while the project submission computer 130 stores data in, and retrieves data from, a submission computer data store 136. These data store locations 116, 136 are representative only, and such data could be stored in the “cloud” and be accessible by accessing the cloud service storing the data over the network 102. The data itself can be stored as files, as raw data, or as data managed by database software. Data could also be stored on one or multiple blockchains.

Agent computers 120 and project submission computers 130 may be anonymous or pseudonymous (e.g., the only information about their identity is a wallet address on a blockchain), or they may voluntarily verify their identity or provide additional identifying information. System 100 is designed to function without requiring personally identifiable information but can incorporate this information as required or desired by participants.

### Method 200

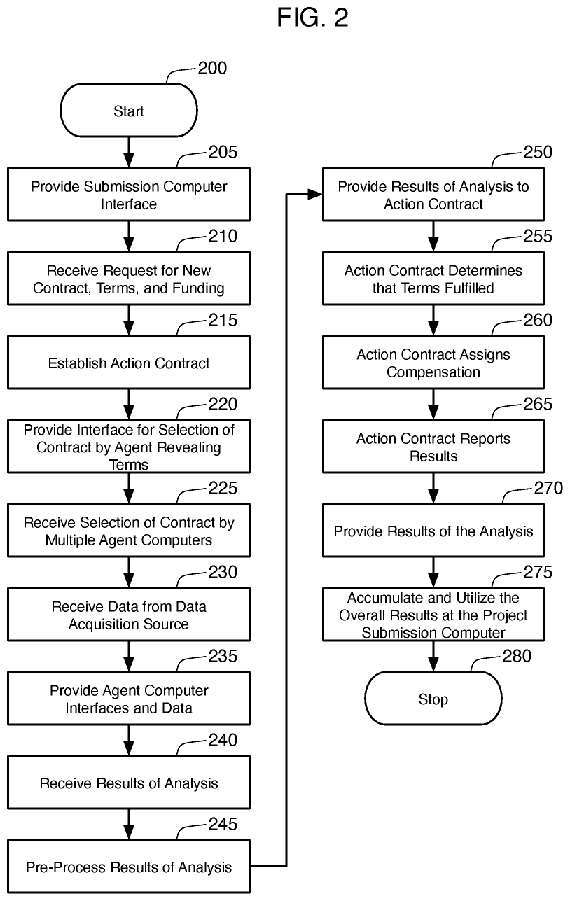

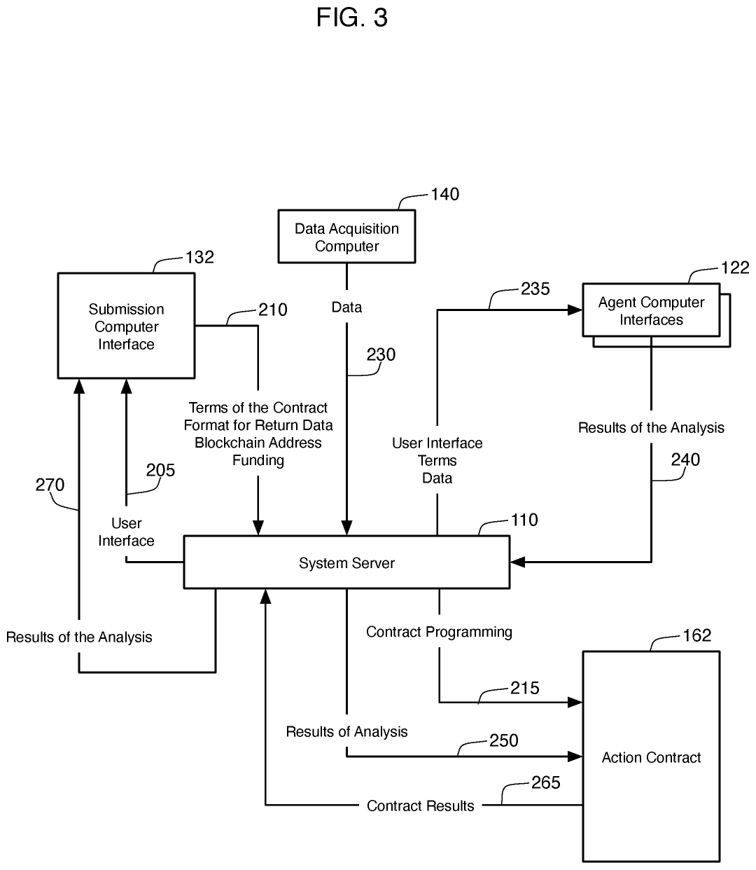

FIG. 2 is a flow chart that shows method 200 for performing one embodiment of the present invention. FIG. 3 schematically shows the flow of data between the different programmed elements of FIG. 1 during method 200.

### Creation of the Action Contract 162

Method 200 begins with step 205, during which the system server 110 provides the submission computer interface 132 to the project submission computer 130. As explained above, the provision of the submission computer interface 132 could be accomplished by operating a web server as part of the system server 110, with the project submission computer 130 having a browser that then receives the submission computer interface 132 from the web server. Alternatively, the submission computer interface 132 could be generated by an application or app that operates on the project submission computer 130. This app could come from an app store associated with a mobile device, or the application could be downloaded from a download location on network 102.

Using submission computer interface 132, a submission user can submit a project to the system 100, which will trigger the formation of a smart contract in the form of action contract 162. In at least one embodiment, form versions of the programming for different action contracts 162 can be pre-programmed and be stored at the system server 110, such as on system data store 116. The action contract 162 is then customized based on the project defined through the submission computer interface 132. To select a particular project, the submission computer interface 132 allows selection of a particular project type. Based on the selection of that project type, the submission computer interface 132 then presents parameters that can be individually selected and input by the user to customize the submitted project. The particulars of the submitted project are then used to customize the action contract 162.

For example, one project type might relate to having users identify objects in images or in video streams. If a user selected this project type through the submission computer interface 132, the user would then be prompted to provide input to various parameters relating to this project type, such as:
1) a source of the images or video stream(s) (which might be the data acquisition computer 140, or could be a location in one or more of the data stores 116, 136 containing a plurality of previously generated images),
2) the type of identification required by the agent, such as a selecting an identified object from a list (does this image show a person or a shadow?), a number input for counting items (how many lions are at the watering hole in this picture?), a binary input (does the image show a burglar breaking into this jewelry store at the present time?), etc.
3) prompts for presentation to the agent, including instructions to the agent and possible options available as answers in the identification process,
4) total funding of the smart contract,
5) the submitter blockchain address 134 to be used for funding and refunds,
6) verification criteria that prove that the agent is putting forth effort to accurately perform the task (such as minimum scores on testing tasks, or correctly responding to attention seeking prompts),
7) requirements and/or criteria that must be met before funding (such as requiring that four separate agents agree on a common identification answer before payments are made to any of the agents),
8) funding paid out to each individual that meets the criteria, and
9) the desired format for data reporting, that describe how acquired answers from the agents are provided back to this project submission computer 130.

At step 210, the system server 110 receives back from the submission computer interface 132 a request to create a new action contract 162. This request will identify the type of smart contract and the relevant parameters (such as those identified immediately above).

At step 215, a new smart contract is created on the blockchain 160 in the form of the action contract 162. This action contract 162 takes the form selected in the submission computer interface 132. The parameters are used to customize this action contract 162 as appropriate for this project. In some circumstances, model smart contracts are pre-created that can be easily modified according to the selected parameters. This contract is then funded according to the funding identified by the project submission computer 130, with the appropriate tokens being transferred from the submitter blockchain address 134 to the action contract 162. The actual funding of the action contract 162 could also take place through other means. For instance, the submission computer interface 132 can submit the request to create the action contract 162, but the project submission computer 130 could then fund the action contract 162 through a direct communication to the blockchain 160 that does not pass through the system server 110. Alternatively, the project submission computer 130 could specify a real-world currency amount for funding of the action contract 162 (e.g., $10,000), and the server system 110 would then be responsible for accumulating a sufficient quantity of tokens 164 on the blockchain 160 equivalent to that funding amount, and then assigning these accumulated tokens 164 to the action contract 162.

### Selection, Performance, and Collaboration

At step 220, the system server 110 provides an interface that identifies all available action contracts 162 available for selection by the agent computers 120. This interface (not shown in the figures) can list all available action contracts 162 needing agent computers 120 to perform tasks for their projects. Agents can peruse and search this list to find an action contract 162 that interests them. A project submission computer 130 can specify how they want to list or otherwise advertise their action contracts 162. Operators of system servers 110 may, for example, collect fees in order to advertise contracts. In some embodiments, the fees for listing the action contract 162 and operating the system 100 are incorporated into the action contract 162 such that the smart contract allocates compensation to a blockchain address associated with the system server 110 upon successful performance of the action contract 162.

System servers 110 may store metadata about agent computers 120 and project submission computers 130 (or, more accurately, about users associated with accounts that use the agent computers 120 and project submission computer 130). This metadata, which may include reputation scores, can be stored by the system server 110 in the system data store 116. Alternatively, these reputation scores can be stored directly on the blockchain 160 and be associated with agent blockchain addresses 124 or submitter blockchain addresses 134, as appropriate. Action contracts 162 may have reputational requirements for agent computers 120 in order for the agent computer 120 to be accepted for performance under the action contract 162. These requirements can be used when advertising or otherwise displaying the action contract 162 to agent computers 120 so that only action contracts 162 are shown that would accept the agent computers 120 for performance. Reputations may be updated automatically (e.g., by completion of action contracts 162) or manually by agent computers 120 and project submission computers 130 (e.g., by leaving reviews). Project submission computers 130 are incentivized to behave properly in the marketplace since agent computers 120 may view the reputations of project submission computer 130 responsible for submitting a particular action contract 162 before selecting to participate in an action contract 162 for a project.

One of the agent computers 120 can then elect to begin performing under action contract 162 at step 225. At this point, the system server 110 will ensure that the data to be processed (such as an image from the data acquisition device 142 made available through the data acquisition computer 140) has been received at step 230. If so, the system server 110 will then provide an appropriate agent computer interface 122 to the electing agent computer 120 at step 235.

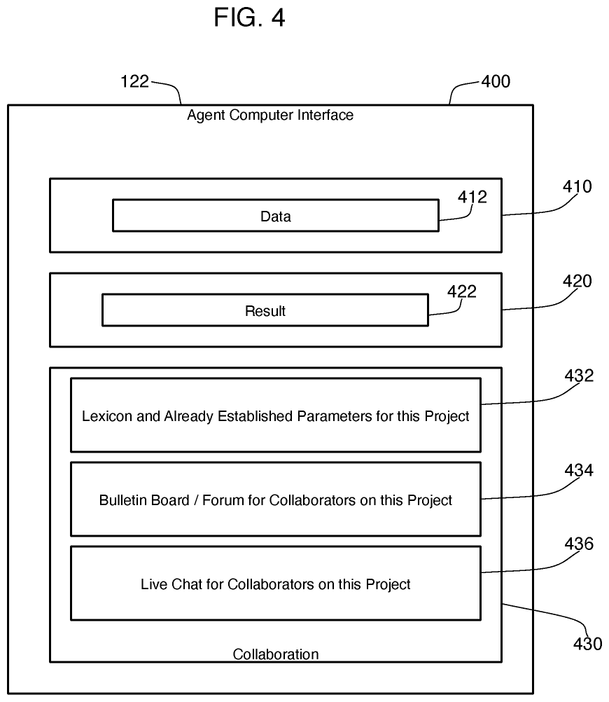

An example of such an agent computer interface 122 is shown in interface 400 of FIG. 4. This interface 400 contains three primary portions, namely a data portion 410, a result portion 420, and a collaboration portion 430. The data portion 410 shows data 412. This data 412 was received from the data acquisition computer 140 was presented by the system server 110 to the agent computers 120 as part of this task. The agent user will analyze this data 412 and then input a result 422 into the result portion 420 of the interface 400.

The collaboration portion 430 is used by the agent user of this interface 400 to communicate through other versions of this interface 400 used by other agent users working on the same project. This is useful because multiple agent computers 120 may be working to complete an action contract 162 and communications may be required between these agent computers 120. For instance, an action contract 162 might involve interpreting and translating text that appears in an image, with a plurality of agent computers 120 being requested to transcribe different portions of the image. Consistency in the translation between the different agent computers 120 is important to achieving a quality result. Thus, the collaboration portion 430 allows inter-communication between the different agent computers 120 concerning this project. For instance, subsection 432 can allow particular rules or decisions concerning this project to be shared with all participants. In a translation project, the lexicon used by prior translators can be shared so that identical source words or symbols are translated consistently in future work on this project. Subsection 434 can provide a bulletin board or forum that allows a variety of topics/questions to be created, with all participants in the project able to view question/topics and answers, and also contribute to the forum in a way that others can see. Finally, subsection 436 might present a live chat window for all agents currently working on the project. A live chat window might be particularly useful if the project relates to live monitoring of a video feed. For example, security camera signals might be monitored as the data 412, and multiple agent computer interfaces 122 can be presented to multiple agent computers 120 so as to monitor a suspicious security camera signal when it arises. The live chat would allow agents to communicate with each other about what is being seen in the data 412 before presenting their analysis as a result 422 in the result portion 420. The goal of these various subsections 432, 434, 436 is to ensure that the collaboration portion 430 enhances the collaboration of multiple agents working on a project through interface 400.

Like the action contract 162, the agent computer interface 400 can be pre-programmed according to the type of project selected by the project submission computer 130 and then modified to conform to the selected parameters. In other words, this pre-programmed interface can be suited to accommodate any of the parameter selections made by the project submission computer 130 so that the presented the agent computer interface 400 is customized for this specific action contract 162. For example, the agent computer interface 400 might, for instance, present an image 400 to the agent user, and request the agent user i) to determine whether a person or a shadow is present in the image, or 2), count the number of lions that are at the watering hole in the image, or 3) answer whether or not a burglar is breaking into a jewelry store in this image. The answer (result 422) to this question would be input into the result portion 420 of the interface. Of course, the data 412 presented might take different forms than a still image. For example, a live video feed could be presented as the data 412, and the agent would be asked to answer a question for the current time in the live video feed. Other types of data 412 are also possible.

At step 240, the agent computer interface 122 sends back to the system server 110 the result 422 of the analysis that was input into the interface 400. The format of this result 422 will be based upon the programming of the agent computer interface 122. As necessary, the system server 110 can then pre-process this result 422 to convert it into a form that can be used by the action contract 162 (step 245). Pre-processing is not always necessary, as the agent computer interfaces 122 can provide a result 422 of the analysis in a form that can be directly used by the action contract 162. At step 250, the system server 110 provides the result 422 of the analysis (after pre-processing, if done) to the action contract 162 residing on the blockchain 160. This submission is generally made through an application binary interface (or ABI) or application programming interface (or API) that is specific to this smart contract. The ABI or API specifies how to interact with the action contract 162, including the methods, parameters, and data structures supported by the contract 162.

### Verification, Requirements, and Compensation

At step 255, the action contract 162 takes the received result 422 of the analysis and determines whether the terms of the action contract 162 have been fulfilled and whether compensation should be provided to the agent blockchain address 124. If so, step 260 will transfer tokens 164 assigned to the action contract 162 to the agent blockchain address 124 associated with the agent computer 120 that submitted the response.

The action contract 162 may require some verification that the performance of the agent computers 120 is adequate. Verification might take the form of test questions. For example, if lions are to be counted near a watering hole, some images with a known, accurate count could be presented through the agent computer interfaces 122 to ensure that care is being taken in performing the action. Such test questions could be interspersed into live data 412. If the test questions are being responded to accurately, the work of the agent computer 120 can be verified. Alternatively, if the agent computer 120 were monitoring a live video feed, intermittent tests could be transmitted in the middle of the feed, or overlayed on top of the feed. The agent monitoring the feed using interface 400 must respond to these intermittent tests appropriately in a reasonable time period in order for their work to be considered verified. In some embodiments, these verification criteria are analyzed by the action contract 162 using the submissions received from the system server 110. In other embodiments, the system server 110 handles the validation testing, and only submits a result 422 to the action contract 162 after the work of the agent computers 120 has been properly validated.

In some contexts, the result 422 received at step 240 from the interface 400 can be directly verified. For instance, an action contract 162 may require running an image processing algorithm on an image. An agent computer interface 122 would complete the requirements of the action contract 162 by using the computational resources of the agent computer 120 to run the algorithm on a particular image 412 and then return the result 422. The algorithm could also be embedded within the code of the action contract 162, and the image 412 itself could be periodically supplied to the action contract 162 along with the result 422 from the agent computer interfaces 122. The cryptographic properties of the blockchain 160 could ensure that the code embedded within the action contract 162 is run as intended without tampering. Because of the extreme costs of performing this analysis on the blockchain 160, the action contract 162 would only periodically be asked to run the algorithm on actual image data 412 to verify the work of the agent computers 120. But faulty processing by the agent computers 120 could be detected whenever such work was done by the action contract 162.

In addition, an action contract 162 may ensure that requirements criteria be fulfilled before any rewards from the action contract 162 to be granted. For example, the action contract 162 may require that five images be analyzed before any compensation be awarded. If only four images have so far been analyzed by the agent computer 120, the action contract 162 will record this fact but will not provide any reward because the requirements criteria were not fulfilled.

Alternatively, the action contract 162 may require that multiple, different agent computers 120 analyze each image provided by the data acquisition computer 140 before any award is distributed. Thus, a plurality of agent computers 120 would have to participate in the project and send results to the system server 110. Each of these results is then provided to the action contract 162, and the terms of the contract 162 will track whether the required multiple results have been received for a particular image. If so, the terms of the action contract 162 will be considered fulfilled for that image, and compensation will be provided to the appropriate agent blockchain addresses 124. In another embodiment, the system server 110 accumulates the results received at step 240 until results are received from the required number different agent computers 120 for the same image (for example, five results). Only at this point are all five results submitted to the action contract 162. In a still further embodiment, all submissions to the action contract 162 for a given time period are batched together and presented at once, with the action contract 162 determining when and whether the terms have been fulfilled for any particular image.

An action contract 162 does not need to correspond to a discrete or single action. For instance, a project submission computer 130 may fund an action contract 162 with a large pool of rewards. The project submission computer 130 may then continuously update the action contract 162 with new or updated data. Agent computers 120 may observe the contract and perform actions as a continuous stream of data is supplied. Effectively, one or more agent computers 120 can wait in a virtual waiting room for new data and provide immediate service on live data when available. Fractions of the reward pool that was used to fund the action contract 162 may be issued to the agent blockchain addresses 124 every time they perform an action on new data. In this way, the action contract 162 may remain open for an extended period of time. During this time period, the agent computer interfaces 122 are periodically presented to the agent computers 120 to analyze data under the contract, results will be received from the agent computer interfaces 122, and rewards will be granted to agent blockchain addresses 124 throughout the lifetime of the action contract 162. This mode of operation enables real-time data processing and supports applications such as the continuous and potentially uninterrupted monitoring of systems, and even allows performance by multiple agent computers 120 simultaneously.

### Sharing of the Results

At step 265, the results produced by the action contract 162 are shared back to the system server 110. These results can indicate which of the results 422 received at step 250 were verified as fulfilling the terms of the action contract 162 and which of the agent blockchain address 124 were compensated as a result. The system server 110 can then share the results from the action contract 162 as well as the results 422 of the analysis received at step 240 with the project submission computer 130 and the submission computer interface 132 (step 270).

The project submission computer 130 will likely store and accumulate the results 422 that it receives at step 270 in its own project submission data store 136. In most circumstances, the entire purpose of using the system 100 and funding the action contract 162 is to gather this data. Thus, the storage of this data in data store 136, and the further analysis of the results at step 275 is an important part of this overall method 200. The method 200 then ends at step 280.

### Alternative Embodiments and Messaging

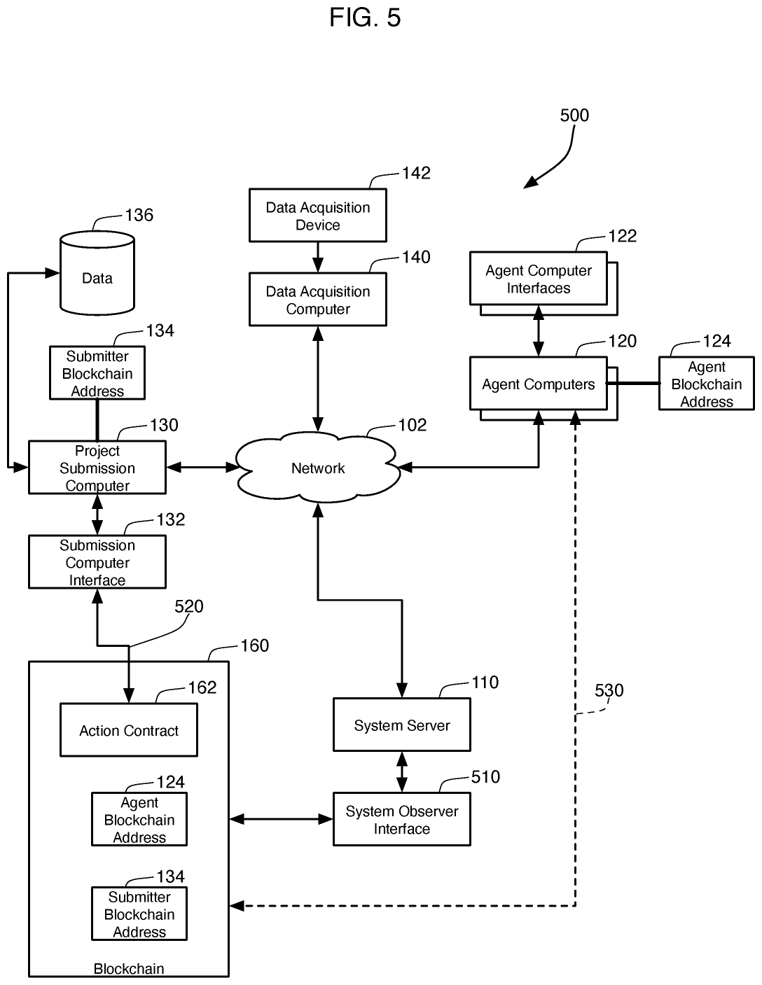

FIG. 5 shows a variety of alternative elements that could be separately added to system 100, but are presented here as a separate alternative system 500. In this figure, a system observer interface 510 is presented by the system server 110 to help with the administration of the system 500. The system observer interface 510 may interact with or view the behavior of agent computers 120 and project submission computers 130, without necessarily benefitting from rewards that are issued for completing action contracts 162. The system observer interface 510 has a direct connection to the blockchain 160, and thus is able to directly audit the action contracts 162. The system 500 can also gather statistics about its various components and report these statistics though the system observer interface 510.

In system 500, the results of the analysis received at step 240 can be received directly by the project submission computer 130. In system 500, it is the project submission computer 130 that executes any pre-processing of the results at step 245 and submits analysis results to the action contract 162 at step 250 (as shown by arrow 520).

Alternatively, programming in the agent computer interfaces 122 can cause the agent computers 120 to directly report results (such as result 422) to the action contract 162 in the blockchain 160 (as shown by arrow 530). In this embodiment, there is no need for either the system server 110 or the project submission computer 130 to submit results to the action contract 162.

The above discussion generally describes the performance of collaborative projects that require human participation by a plurality of agents. However, it is not always necessary that the action include a direct human contribution. An example was provided above, for instance, in which the action required consisted solely of the agent computers 120 running an algorithm on provided data. Thus, while particular benefits are provided when human interaction and analysis is required in these collaborative projects, it is possible for embodiments to be fully automated. Furthermore, in alternative embodiments, the agent computers 120 can be operated by someone other than independent operating humans, such as a legal entity (such as a corporation or a government). Thus, a corporate entity could perform the action of the agent in the above embodiments. In still further embodiments, artificial entities (including but not limited to software programs, hardware devices, sensors, or artificial intelligence engines) could perform these actions. Furthermore, the role of the project submitter may also be performed by legal or artificial entities.

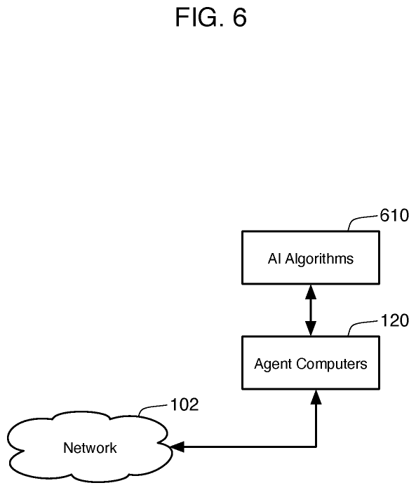

FIG. 6 shows the agent computers 120 of FIG. 1. As explained above, the agent computers 120 receive data and a means to perform an action on the data. In FIG. 1, the means to perform the action is the agent computer interfaces 122, which can present a user interface for human interaction with the data. In FIG. 6, the actions take place through requests to artificial intelligence algorithms 610 hosted at the agent computers 120. The artificial intelligence algorithms 610 can be specially programmed deep learning systems operating on the agent computers 120 trained to perform the exact action specified by the action contract 162. Alternatively, the artificial intelligence algorithms 610 could be general purpose algorithms, and could be operated on remotes systems. In such a system, the agent computers 120 are responsible for receiving action parameters and data from the system server 110 and then submitting the data and the request for analysis to a remotely hosted artificial intelligence algorithm 610. Recent studies, such as that described in “ChatGPT Outperforms Crowd-Workers for Text-Annotation Tasks” (by Fabrizio Gilardi, Meysam Alizadeh, Maël Kubli, Mar. 27, 2023, arXiv:2303.15056), indicated that for some text-based actions that are generally submitted to crowd-sourced human participants, ChatGPT (created by OpenAI of San Francisco, CA) outperformed human workers on the same actions. In one embodiment, the artificial intelligence algorithms 610 are ChatGPT systems, systems based on GPT-4 (also from OpenAI), or similar systems.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

1. A method comprising:
a) receiving at a server computer a request for a project and an identification of a data source for live video data;
b) at the server computer, causing an action contract to be created, the action contract comprising a smart contract created on a blockchain, the action contract being customized to the project;
c) at the server computer, presenting a first agent computer interface to a first agent computer and a second agent computer interface to a second agent computer, the agent computer interfaces both being customized to the project and both comprising a collaboration portion to allow inter-communication;
d) at the server computer, presenting the live video data retrieved from the data source through the first agent computer interface and while presenting the live video data to the second agent computer interface;
e) at the same time that the live video data is being presented in both the first agent computer interface and the second agent computer interface, providing live communications from the first agent computer interface to the second agent computer interface through the collaboration portions;
f) at the server computer, receiving a first result from the first agent computer interface and a second result from the second agent computer interface; and
g) presenting the first result and the second result to the action contract, resulting in compensation being provided to a first blockchain address associated with the first agent computer and a second blockchain address associated with the second agent computer.

2. The method of claim 1, wherein the request for the project further comprises a plurality of parameters, wherein the action contract and the agent computer interfaces are customized according to the plurality of parameters.

3. The method of claim 0, wherein the request for the project further comprises a project type, wherein the plurality of parameters define elements of the project type.

4. The method of claim 3, wherein the server computer provides a submission computer interface to a project submission computer, wherein the submission computer interface receives the project type and then presents the plurality of parameters related to the project type for selection through the submission computer interface.

5. The method of claim 1, where the request for the project is received from a project submission computer, further comprising, at the server computer, presenting the first result and the second result to the project submission computer.

6. The method of claim 1, wherein a first agent blockchain address is associated with the first agent computer and a second agent blockchain address is associated with the second agent computer, and further wherein the action contract transfers tokens to the first agent blockchain address and the second agent blockchain address.

7. The method of claim 6, further comprising verifying the first result before transferring the tokens to the first agent blockchain address.

8. The method of claim 7, wherein verifying the first result comprises monitoring prior actions on the first agent computer.

9. The method of claim 8, wherein monitoring the prior actions on the first agent computer comprises presenting testing data through the first agent computer interface within the live video data and monitoring actions received from the first agent computer interface in response to the testing data.

10. The method of claim 7, further comprising ensuring that requirements criteria are fulfilled before transferring the tokens to the first agent blockchain address.

11. The method of claim 10, wherein the requirements criteria are fulfilled as a result of the second result being received from the second agent computer interface.

12. The method of claim 7, wherein the action contract is responsible for verifying the first result.

13. The method of claim 1, further comprising, at the server computer, pre-processing the first result and the second result to generate processed results, and then presenting the processed results to the action contract.

14. (canceled)

15. The method of claim 1, wherein the collaboration portion includes a live chat communication between the first agent computer interface and the second agent computer interface.

16. The method of claim 1, wherein the first agent computer interface and the second agent computer interface both provide interfaces to artificial intelligence algorithms.

17. A method comprising:
a) receiving at a server computer a request for a project from a submission computer interface operating on a submission computer by:
i) receiving from the submission computer interface a project type,
ii) selecting a plurality of parameters based on the project type,
iii) presenting parameters requests for the plurality of parameters through the submission computer interface, and
iv) receiving input for the plurality of parameters from the submission computer interface;
b) at the server computer, causing an action contract to be created, the action contract comprising a smart contract created on a blockchain, the action contract being configured based on the project type and the input for the plurality of parameters;
c) at the server computer, receiving live video data that requires analysis;
d) at the server computer, presenting a first agent computer interface to a first agent computer, the first agent computer interface being customized to the project;
e) at the server computer, presenting the live video data through the first agent computer interface while providing live communications from the first agent computer interface to a second agent computer interface that is also receiving the live video data;
f) at the server computer, receiving a first result from the first agent computer interface; and
g) presenting the first result to the action contract, resulting in compensation being provided to a first blockchain address associated with the first agent computer.

18. The method of claim 17, further comprising:
i) providing a second agent computer interface to a second agent computer,
ii) presenting the data that was presented through the first agent computer interface to the second agent computer interface,
iii) receiving a second result from the second agent computer interface, and
iv) presenting the second result to the action contract, resulting in compensation being provided to a second blockchain address associated with the second agent computer.

19. The method of claim 18 wherein the first result and the second result require human analysis, further wherein the first agent computer interface and the second agent computer interface both comprise a collaboration portion to allow inter-communication.

20. A method comprising:
a) receiving at a server computer a request for a project and an identification of a data source from a project submission computer;
b) at the server computer, presenting a first agent computer interface to a first agent computer and a second agent computer interface to a second agent computer, the agent computer interfaces being customized to the project;
c) at the server computer, presenting a live data stream retrieved from the data source through the first agent computer interface and the second agent computer interface and, at the same time that the live data stream is being presented in both the first agent computer interface and the second agent computer interface, providing live communications from the first agent computer interface to the second agent computer interface through a collaboration portion;
d) at the server computer, receiving a first result from the first agent computer interface and a second result from the second agent computer interface;
e) verifying the first result and the second result by inserting tests within the live data stream requiring appropriate responses to made within a time period, and
f) submitting the first result and the second result to the project submission computer.

21. The method of claim 17, wherein the first agent computer interface is pre-programmed based on the project type and then modified to conform to the input for the plurality of parameters.
